(19) United States
(12) Patent Application Publication
(10) Pub. No.: US 2016/0198049 A1
(43) Pub. Date: Jul. 7, 2016

(54) WIRELESS COMMUNICATION SYSTEM AND METHOD FOR CHARGING CONTROL

(71) Applicant: NEC CORPORATION, Tokyo (JP)

(72) Inventor: Takanori IWAI, Tokyo (JP)

(73) Assignee: NEC CORPORATION, Tokyo (JP)

(21) Appl. No.: 14/911,622

(22) PCT Filed: Jun. 9, 2014
(86) PCT No.: PCT/JP2014/003062

§ 371 Date: Feb. 11, 2016

(30) Foreign Application Priority Data
Aug. 12, 2013 (JP) 2013-167630

(51) Int. Cl. H04M 15/00; H04W 4/00; H04W 4/24

(52) U.S. Cl. CPC H04M 15/66; H04W 4/24; H04W 4/005; H04M 15/8271

(57) ABSTRACT

A wireless communication system includes an entity (1) configured to send a charging rule generation indication to a PCEF (55) in response to receiving, from an SCS (2), a device action request containing trigger information to be sent to an MTC device (3). The charging rule generation indication contains a first address specifying a node or a network with which the MTC device communicates when the MTC device receives the trigger information. It is thus possible, for example, to allow charging a communication fee for the MTC device to a party having used the MTC device.

### TECHNICAL FIELD

The present application relates to charging control of Machine Type Communication (MTC).

### BACKGROUND ART

NPL1 specifies charging functions and charging management in a packet switched network according to Third Generation Partnership Project (3GPP). In most cases, a packet transfer node (e.g., Serving General Packet Radio Service (GPRS) Support Node (SGSN), Gateway GPRS Support Node (GGSN), Serving Gateway (S-GW), Packet Data Network Gateway (P-GW)) in a core network has a Charging Trigger Function (CTF) and a Charging Data Function (CDF). In the framework of charging management, a packet transfer node in a core network is called Packet Switched Core Network Node (PCN). Specifically, a PCN serving as a CTF collects charging information about a chargeable event, and the PCN serving as a CDF creates a Charging Data Record (CDR) for each predetermined charged party based on the collected charging information.

The chargeable event is an activity that uses resources or services served by a communication network. The chargeable event, for example, is user to user communication (e.g., a single call, a data communication session or a short message), user to network communication (e.g., service profile administration), inter-network communication (e.g., transferring calls, signalling, or short messages), or mobility (e.g., roaming or inter-system handover).

The Charging Data Record (CDR) is formatted collected charging information (e.g., a call time, a data transfer amount etc.). In some cases, one chargeable event is segmented into a plurality of charging units by a predetermined time limit (call time) or a predetermined data volume limit. Further, in some cases, a plurality of charged parties are charged with one chargeable event. Thus, one or more CDRs may be created for one chargeable event.

Further, 3GPP, European Telecommunications Standards Institute (ETSI) and the like contemplates standardization of Machine Type Communication (MTC). The MTC is also called a Machine-to-Machine (M2M) network or a sensor network. The 3GPP defines mobile stations (MSs, UEs) that are mounted on machines or sensors for the MTC as “MTC devices”. The MTC devices are mounted on various types of equipment including machines (e.g., vending machines, gas meters, electricity meters, automobiles, a railway vehicles) and sensors (e.g., environmental, agricultural, or traffic sensors). The MTC devices are connected to a Public Land Mobile Network (PLMN) and communicate with an MTC application server (AS). The MTC application server is placed outside of the PLMN (external network), executes an MTC application and communicates with MTC UE applications implemented in the MTC devices. In most cases, the MTC application server is typically controlled by an MTC service provider (M2M service provider).

The 3GPP defines network architecture including a Service Capability Server (SCS) and a Machine Type Communication Inter Working Function (MTC-IWF) and reference points (interfaces) related to those in order to allow the MTC application server to communicate with the MTC device. The SCS is an entity that connects the MTC application server to the PLMN defined by the 3GPP and allows the MTC application server to communicate with a UE (i.e., MTC device) through a PLMN service defined by the 3GPP. Further, the SCS allows the MTC application server to communicate with MTC-IWF. It is assumed that the SCS is controlled by an operator of the PLMN or the MTC service provider.

The MTC-IWF is a control-plane entity that belongs to the PLMN. The MTC-IWF has a connection with the SCS and also has connections with nodes in the PLMN (e.g., Home Subscriber Server (HSS), Short Message Service-Service Center (SMS-SC), Serving GPRS Support Node (SGSN), Mobility Management Entity (MME), Mobile Switching Center (MSC)). The MTC-IWF serves as a control-plane interface to allow the 3GPP PLMN and the M2M service layer including the SCS to cooperate (interwork) with each other while hiding the details of the topology of the 3GPP PLMN.

NPL2 describes optimization of charging related to the MTC (see Section 8.2 in NPL2). Specifically, NPL2 describes to create a bulk CDR on an MTC group including a plurality of MTC devices, instead of creating CDRs on individual MTC devices.

### CITATION LIST

### Non Patent Literature

NPL1: 3GPP TS 32.251 V11.6.0 (March 2013) “3rd Generation Partnership Project; Technical Specification Group Services and System Aspects; Telecommunication management; Charging management; Packet Switched (PS) domain charging (Release 11)”, March 2013

NPL2: 3GPP TR 23.887 V0.9.0 (April 2013) “3rd Generation Partnership Project; Technical Specification Group Services and System Aspects; Machine-Type and other Mobile Data Applications Communications Enhancements (Release 12)”, April 2013

### SUMMARY OF INVENTION

### Technical Problem

The present inventor conducted studies assuming a use case where one MTC device is used by a plurality of SCSs, a plurality of MTC application servers or a plurality of MTC service providers. The phrase “using the MTC device” means to perform data communications with the MTC device on either uplink or downlink or both. A possible example is a case where one MTC device mounted on an automobile is shared among an MTC application server of an automobile manufacturer, an MTC application server of a highway administrator, and MTC application servers of traffic information providers.

In such a use case, it may be more appropriate that communication fees for the MTC device are charged on individual parties who have used the MTC device (i.e., an administrator of the SCS, an administrator of the MTC application server, or the MTC service provider), rather than being charged on a subscriber of the MTC device. However, in the use case where the MTC device is used by a plurality of parties, there is no satisfactory mechanism for charging communication fees for the MTC device to individual parties who have used the MTC device. In order to implement such charging, for example, a Packet Switched Core Network Node (PCN) with CTF and CDF is needed to create CDRs that contain charging information collected for individual parties who have used one MTC device, not for each MTC device (i.e., each UE).

The present invention has been accomplished based on the above-described findings by the present inventor. Accordingly, an object of the present invention is to provide a method and an apparatus that make it possible to charge communication fees for an MTC device to individual parties who have used the MTC device in a use case where a plurality of parties use the MTC device.

### Solution to Problem

In a first aspect, a wireless communication system includes a control entity configured to send a charging rule generation indication to a Policy and Charging Rule Function (PCRF) entity in response to receiving, from a Service Capability Server (SCS), a device action request containing trigger information to be sent to a Machine Type Communication (MTC) device. The charging rule generation indication contains a first address specifying a node or a network with which the MTC device communicates when the MTC device receives the trigger information.

In a second aspect, a method for charging control includes sending a charging rule generation indication to a Policy and Charging Rule Function (PCRF) entity in response to receiving, from a Service Capability Server (SCS), a device action request containing trigger information to be sent to a Machine Type Communication (MTC) device. The charging rule generation indication contains a first address specifying a node or a network with which the MTC device communicates when the MTC device receives the trigger information.

In a third aspect, a program contains instructions causing a computer to perform the method according to the second aspect described above.

In a fourth aspect, a wireless communication system includes a Machine Type Communication Inter Working Function (MTC-IWF) entity, a Policy and Charging Rule Function (PCRF) entity, and a packet transfer node. The MTC-IWF entity is configured to receive from a Service Capability Server (SCS) a device action request containing trigger information. Further, the MTC-IWF entity is configured to send a device trigger request containing the trigger information to a serving node in response to receiving the device action request. Furthermore, the MTC-IWF entity is configured to send a charging rule generation indication to the Policy and Charging Rule Function (PCRF) entity in response to receiving the device action request. The charging rule generation indication contains a first address specifying a node or a network with which a target Machine Type Communication (MTC) device communicates on a user plane in response to delivery of the trigger information based on the device trigger request. The PCRF entity is configured to generate a charging rule in response to the charging rule generation indication. The charging rule defines at least one of an uplink packet flow to be sent from the target MTC device where the first address is designated as a destination address and a downlink packet flow to be sent to the target MTC device where the first address is designated as a source address. The PCRF entity is configured to send the charging rule to a packet transfer node placed in a core network. The packet transfer node is configured to count at least one of the uplink packet flow and the downlink packet flow based on the charging rule and create a Charging Data Record (CDR) containing charging information collected with regard to the first address.

### Advantageous Effects of Invention

According to the above-described aspects of the present invention, it is possible to provide a method and a device that make it possible to charge communication fees for an MTC device to individual parties who have used the MTC device in a use case where a plurality of parties uses the MTC device.

### BRIEF DESCRIPTION OF DRAWINGS

FIG. 1 is a view showing a configuration example of a wireless communication network that supports MTC.

FIG. 2 is a sequence chart showing one example of a charging control method according to a first embodiment.

FIG. 3 is a block diagram showing a configuration example of an MTC-IWF entity according to the first embodiment.

FIG. 4 is a flowchart showing one example of an operation for charging in an MTC-IWF entity according to the first embodiment.

FIG. 5 is a flowchart showing one example of an operation for charging in a PCRF entity according to the first embodiment.

FIG. 6 is a flowchart showing one example of an operation for charging in a GGSN/P-GW according to the first embodiment.

FIG. 7 is a sequence chart showing one example of a charging control method according to a second embodiment.

### DESCRIPTION OF EMBODIMENTS

Specific embodiments of the present invention will be described hereinafter in detail with reference to the drawings. Note that in the drawings, the same elements are denoted by the same reference signs and repeated description will be omitted as appropriate to clarify the explanation.

### First Embodiment

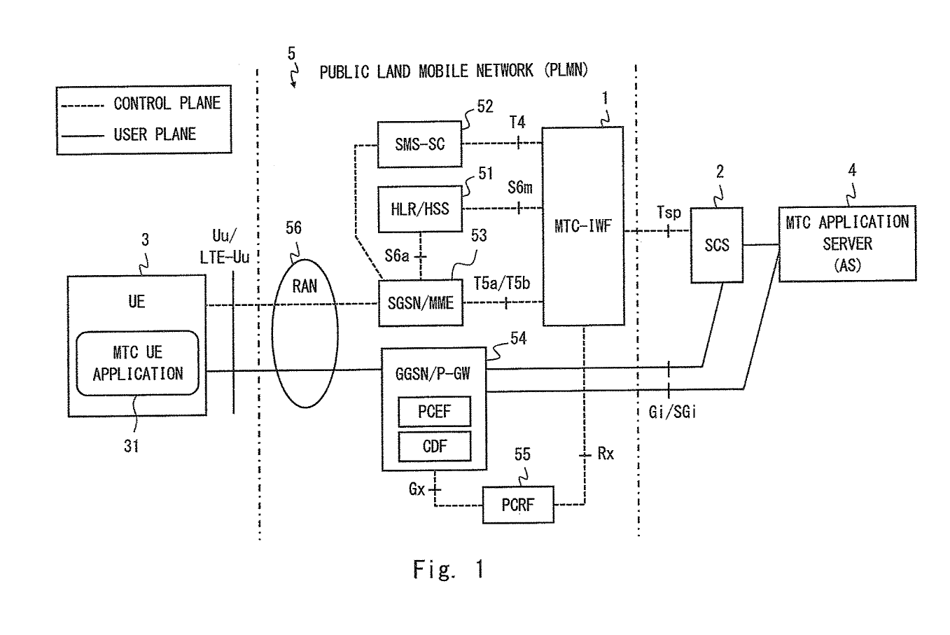

FIG. 1 shows a configuration example of a wireless communication network according to this embodiment. In one example, the wireless communication network according to this embodiment is a Universal Mobile Telecommunications System (UMTS) network or a Long Term Evolution (LTE) network specified by the 3GPP.

The MTC-IWF entity 1 is a control-plane entity that belongs to a PLMN 5. The MTC-IWF entity 1 has a connection with a SCS 2 through a Tsp reference point. The Tsp reference point, for example, is Application Programming Interfaces (API) and uses Diameter-based protocol. Further, the MTC-IWF entity 1 has a connection with nodes in the PLMN 5. In the example shown in FIG. 1, the MTC-IWF entity 1 has a connection with a HLR/HSS 51 through an S6m reference point, has a connection with a SMS-SC 52 through a T4 reference point, and has a connection with an SGSN/MME 53 through a T5a/T5b reference point. The MTC-IWF entity 1 may be a single independent physical entity or a functional entity added to another network element (e.g., HLR/HSS 51 or SGSN/MME 53).

The HLR/HSS 51 is a control-pale node placed in a core network of the PLMN 5 and manages subscriber information of the UE 3.

The SMS-SC 52 transfers Mobile Terminated (MT) short messages and Mobile Originated (MO) short messages.

The SGSN/MME 53 is a control-pale node placed in the core network of the PLMN 5 and performs mobility management (e.g., position registration) of mobile terminals and bearer management (e.g., bearer establishment, bearer configuration modification, bearer release) and the like. The SGSN/MME 53 sends and receives control messages to and from a node (i.e. Radio Network Controller (RNC), eNodeB etc.) in Radio Access Network (RAN) 56, and sends and receives Non-Access Stratum (NAS) messages to and from the UE 3. The NAS messages are not terminated at the RAN 56 and are transparently transmitted and received between the UE 3 and the SGSN/MME 53 without depending on the radio access technology used in the RAN.

The GGSN/P-GW 54 is a user-plane packet transfer node placed in the core network of the PLMN 5 and transfers user data (i.e. Internet Protocol (IP) packets). The GGSN/P-GW 54 serves as a gateway with an external IP network (Packet Data Network in the 3GPP). The GGSN/P-GW 54 has a Charging Opportunity Function (CTF), a Charging Data Function (CDF), and a Policy and Charging Enforcement Function (PCEF). To be specific, the GGSN/P-GW 54 serving as the CTF collects charging information about a chargeable event. The GGSN/P-GW 54 serving as the CDF creates a Charging Data Record (CDR) for each predetermined charged party based on the collected charging information.

Further, the GGSN/P-GW 54 serving as the PCEF performs Quality of Service (QoS) control and Flow Based Bearer Charging (FBC) per service data flow (i.e. IP packet flow) of the UE 3 in accordance with a Policy and Charging Control (PCC) rule supplied from a Policy and Charging Rule Function (PCRF) entity 55. The FBC is implemented by the CTF, the CDF and the PCEF included in the GGSN/P-GW 54. Specifically, the GGSN/P-GW 54 performs filtering on a service data flow of the UE 3, monitors the service data flow as a chargeable event that triggers creation and close of a CDR, counts the number of packets in the service data flow, and creates a CDR containing the charging information related to the service data flow.

The PCRF entity 55 has an interface with PCRF included in the GGSN/P-GW 54 through a Gx reference point, and has an interface with an Application Function (AF) through an Rx reference point. In the example shown in FIG. 1, the PCRF entity 55 is connected with the MTC-IWF entity 1 through the Rx reference point. Specifically, the PCRF entity 55 receives application-level service information from the MTC-IWF entity 1, determines a PCC rule, and supplies the PCC rule to the GGSN/P-GW 54. In some implementations, the PCRF entity 55 may autonomously provide the PCC rule to the GGSN/P-GW 54 (so-called “push-type delivery”) or, alternatively, the GGSN/P-GW 54 may request the PCC rule to the PCRF entity 55 in response to bearer establishment or bearer modification of the UE 3 (so-called “pull-type delivery”).

The PCC rule contains information elements necessary in the PCEF to perform policy control (QoS control) and charging per service data flow of the UE 3. In some implementations, the PCC rule includes a packet filter configuration for a service data flow (i.e., Traffic Flow Template (TFT) or Service Data Flow (SDF) template), a charging configuration (e.g., offline charging, online charging, no charging), a measurement configuration (e.g., time, volume and events to be measured for a service data flow), and a service identifier identifying a service data flow.

The SCS 2 connects an MTC application server 4 to the PLMN 5 and allows the MTC application server 4 to communicate with the UE 3 (i.e. MTC device) through PLMN services defined by the 3GPP. Further, the SCS 2 allows the MTC application server 4 to communicate with the MTC-IWF entity 1. The SCS 2 is controlled by an operator of the PLMN 5 or an MTC service provider. The SCS 2 is also referred to as an MTC server or a M2M server. The SCS 2 may be a single independent physical entity or a functional entity added to another network element (e.g., MTC application server 4).

The UE 3 executes an MTC UE application 31 and serves as an MTC device. The UE 3 as an MTC device is connected to the SGSN/MME 53 through the Radio Access Network (RAN) 56 and communicates with the MTC application server 4. The UE 3 may be an MTC gateway device. The MTC gateway device has a 3GPP mobile communication function (i.e., functions of a UE) and is connected to an adjacent device (e.g., a sensor, a radio frequency identification (RFID) tag, a car navigation device) by personal/local area connection technology. Specific examples of the personal/local area connection technology include IEEE 802.15, ZigBee, Bluetooth, and IEEE 802.11a. The adjacent device, which is connected to the MTC gateway device, is typically a device that does not have the 3GPP mobile communication function, but may be a device that has the 3GPP mobile communication function (i.e., MTC device).

In this specification, the term “MTC device” and the term “MTC gateway device” are used without particularly distinguishing between them. That is, the term “MTC device” used in this specification includes the term “MTC gateway device”. Accordingly, the UE 3 as the MTC device also means the UE 3 as the MTC gateway device.

The MTC-IWF entity 1 and the SCS 2 performs request and confirmation for a device trigger, and notification and confirmation of a result of the device trigger request through the Tsp reference point. Specifically, the MTC-IWF entity 1 receives from the SCS 2 a device action request for triggering the UE 3, which serves as the MTC device. Next, in order to deliver trigger information to the UE 3 in response to the device action request, the MTC-IWF entity 1 sends and receives signaling messages to and from a control node in the PLMN 5. In the 3GPP, for example, the T4 or T5 (T5a, T5b or T5c) reference point is used to deliver the trigger information. In the case of using the T4 reference point, the MTC-IWF entity 1 sends to the SMS-SC 52 the device trigger request for delivering the trigger information. In the case of using the T5 reference point, the MTC-IWF entity 1 sends the device trigger request to the SGSN/MME 53. Then, the MTC-IWF entity 1 receives the result of the trigger information delivery from the SMS-SC 52 or the SGSN/MME 53 and sends the result of trigger information delivery to the SCS 2.

Further, in this embodiment, the MTC-IWF entity 1, the PCRF entity 55 and the GGSN/P-GW 54 operate as follows to make it possible to charge communication fees for one MTC device to individual parties who have used the MTC device in a use case where one MTC device is used by a plurality of parties (i.e. an administrator of the SCS, an administrator of the MTC application server, or a MTC service provider). This embodiment assumes a case where, in response to receiving the device trigger containing the trigger information, the UE 3 (MTC device) performs user-plane data communication with the SCS 2 or the application server 4, which has requested the device trigger. In this embodiment, it is possible to charge a fee of the data communication, which is performed by the UE 3 on the user plane after receiving the device trigger, to the party (i.e. an administrator of the SCS, an administrator of the MTC application server, or an MTC service provider) that has requested transmission of the device trigger.

The MTC-IWF entity 1 receives from the SCS 2 a Device Action Request (DAR) containing trigger information destined for the UE 3 (i.e. target MTC device). In response to receiving the DAR from the SCS 2, the MTC-IWF entity 1 sends a Device Trigger Request (DTR) to the SGSN/MME 53. Note that, in the case of performing the device trigger through the T4 reference point, the MTC-IWF entity 1 may send the DTR to the SMS-SC 52. Prior to sending the DTR, the MTC-IWF entity 1 may make an inquiry to the HLR/HSS 51 to acquire an internal identifier (e.g., International Mobile Subscriber Identity (IMSI)) of the UE 3 that is used in the PLMN 5 and information about the SGSN/MME 53 (which is called a serving node) that is associated with the UE 3.

Further, in response to receiving the DAR from the SCS 2, the MTC-IWF entity 1 sends a charging rule generation indication to the PCRF entity 55. The charging rule generation indication contains a first address specifying a node or a network with which the UE 3 (target MTC device) communicates on the user plane in response to delivery of the trigger information based on the DTR. The first address may be, for example, an IP address or a network address of the SCS 2 that has sent the DAR, or an IP address or a network address of the application server 4 that has requested the DAR to the SCS 2. The DAR may contain the first address. Stated differently, when receiving the DAR from the SCS 2, the MTC-IWF entity 1 may receive the first address from the SCS 2. The charging rule generation indication may contain an internal identifier (e.g., IMSI) of the UE 3 in the PLMN 5 to identify the UE 3. Further, the charging rule generation indication may contain information that charging is performed per service data flow regarding the first address. To be specific, the charging rule generation indication may indicate that charging is performed on a downlink service data flow (IP packet flow) where the first address is a source address, an uplink service data flow (IP packet flow) where the first address is a destination address, or both of them.

The PCRF entity 55 generates a PCC rule in response to the charging rule generation indication. The PCC rule defines the uplink service data flow (IP packet flow) sent from the UE 3 where the first address is designated as a destination address, the downlink service data flow (IP packet flow) sent to the UE 3 where the first address is designated as a source address, or both of them. The PCC rule may indicate the creation of a CDR that contains charging information collected for the service data flow of the UE 3 related to the first address. To be specific, the PCC rule may indicate the acquisition of a packet count and a time stamp of a service data flow as a measurement method.

The PCRF entity 55 sends the PCC rule to the GGSN/P-GW 54 having PCEF and CDF. The PCRF entity 55 may send the PCC rule to the GGSN/P-GW 54 in a push manner. Alternatively, the GGSN/P-GW 54 may send a PCC request to the PCRF entity 55 and receive the PCC rule from the PCRF entity 55 in a pull manner.

The GGSN/P-GW 54 counts, based on the PCC rule, the uplink service data flow where the first address is designated as a destination address, the downlink service data flow where the first address is designated as a source address, or both of them, and creates the CDR that contains the charging information collected with regard to the first address.

By the above-described operations of the MTC-IWF entity 1, the PCRF entity 55, and the GGSN/P-GW 54, the GGSN/P-GW 54 can create a CDR that contains charging information collected per party who has used one MTC device, not per MTC device (i.e., per UE). Therefore, this embodiment makes it possible to charge communication fees for the MTC device to individual parties who have used the MTC device.

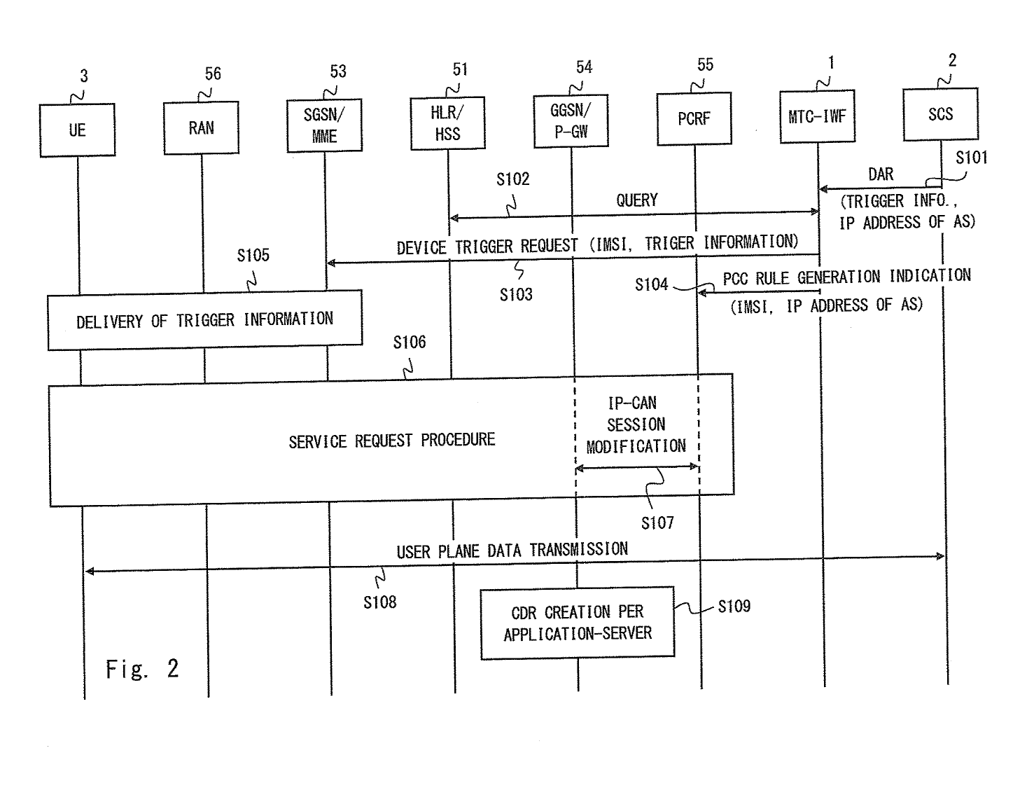

FIG. 2 is a sequence chart showing one example of a charging control method according to this embodiment. In Step S101, the SCS 2 sends a device action request (DAR) to the MTC-IWF entity 1. The DAR contains trigger information to be sent to the UE 3 and contains a first address (i.e., IP address of the application server 4 in this example) for specifying a party who has requested the device trigger. The DAR may further contain an external identifier (e.g., uniform resource identifier (URI)) of the UE 3 (target MTC device).

In Step S102, the MTC-IWF entity 1 makes an inquiry to the HLR/HSS 51 about an internal identifier (i.e., IMSI in this example) of the UE 3 corresponding to the external identifier of the UE 3 and the SGSN/MME 53 (serving node) associated with the UE 3. The MTC-IWF entity 1 selects a SGSN/MME to which a device trigger request (DTR) is to be sent among a plurality of SGSN/MMEs 53 based on a response from the HLR/HSS 51.

In Step S103, the MTC-IWF entity 1 sends the DTR to the selected SGSN/MME 53. The DTR contains the internal identifier (i.e., IMSI in this example) of the UE 3 (target MTC device) and the trigger information to the UE 3.

In Step S104, the MTC-IWF entity 1 sends a PCC rule generation indication to the PCRF entity 55. The PCC rule generation indication contains the internal identifier (i.e., IMSI in this example) of the UE 3 and the first address (i.e., IP address of the application server 4 in this example) for specifying a party who has requested the device trigger. The PCRF entity 55 generates a PCC rule for either an uplink service data flow of the UE 3 related to the first address, or a downlink service data flow of the UE 3 related to the first address, or both.

In Step S105, the SGSN/MME 53 delivers the trigger information to the UE 3. In some implementations, the SGSN/MME 53 may deliver the trigger information to the UE 3 by using a NAS-Protocol Data Unit (NAS-PDU). Various ways are proposed for the delivery of trigger information or small data with use of a NAS-PDU. Alternatively, the trigger information may be delivered as an SMS message to the UE 3. When the UE 3 is in idle mode (e.g., EPS Connection Management IDLE (ECM-IDLE) or Radio Resource Control IDLE (RRC_IDLE)), the SGSN/MME 53 may perform paging through the RAN 56.

In Step S106, in response to receiving the trigger information, the UE 3 initiates a bearer establishment procedure (e.g., Service Request procedure) to perform user-plane data communication. In the bearer establishment procedure, the PCRF entity 55 sends the PCC rule, which has been generated in accordance with the PCC rule generation indication in Step S104, to the GGSN/P-GW 54 (Step S107). The PCRF entity 55 may send the PCC rule to the GGSN/P-GW 54 during an IP Connectivity Access Network (IP-CAN) session Establishment/Modification procedure initiated by the GGSN/P-GW 54 as PCEF. Alternatively, the PCRF entity 55 may send the PCC rule to the GGSN/P-GW 54 in a push manner.

In Step S108, the UE 3 performs user-plane data communication (IP packet communication) with the SCS 2 or the MTC application server 4. The GGSN/P-GW 54 performs policy control (QoS control) and charging per service data flow of the UE 3 in accordance with the PCC rule. Specifically, as shown in Step S109, the GGSN/P-GW 54 monitors a service data flow of the UE 3 and creates a CDR for each party with which the UE 3 communicates (i.e., per MTC application server 4 in this example).

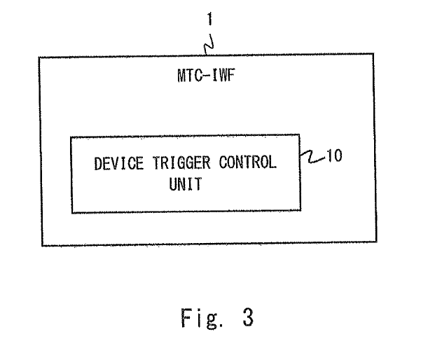

FIG. 3 is a block diagram showing a configuration example of the MTC-IWF entity 1 according to this embodiment. The MTC-IWF entity 1 shown in FIG. 3 includes a device-trigger control unit 10 that controls a device trigger to the UE 3 (MTC device). The device-trigger control unit 10 is configured to receive a DAR containing trigger information from the SCS 2. The device-trigger control unit 10 is configured to send a DTR containing the trigger information to the SGSN/MME 53 in response to receiving the DAR. Further, the device-trigger control unit 10 is configured to send a PCC rule generation indication to the PCRF entity 55 in response to receiving the DAR. As already described above, the PCC rule generation indication contains a first address specifying a node or a network, within an external network (PDN), with which the UE 3 communicates on the user plane in response to the delivery of the trigger information based on the DTR. The first address, for example, is an address of the SCS 2 or the MTC application server 4 managed by a party who has requested the device trigger, or is a network address of the network to which the SCS 2 or the MTC application server 4 belongs.

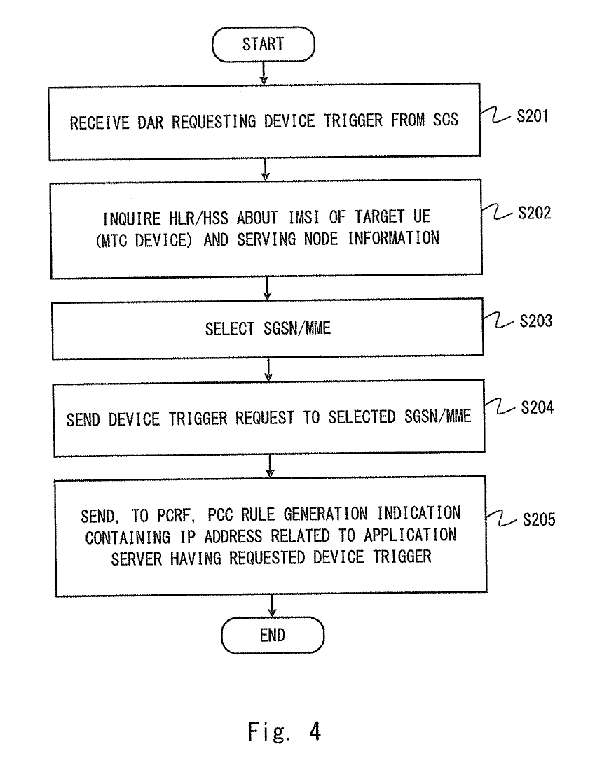

FIG. 4 is a flowchart showing one example of an operation for charging in the MTC-IWF entity 1 according to this embodiment. In Step S201, the MTC-IWF entity 1 receives a DAR requesting device trigger from the SCS 2. In Step S202, the MTC-IWF entity 1 makes an inquiry to the HLR/HSS 51 about the IMSI of the UE 3 (target MTC device) and serving node information.

In Step S203, the MTC-IWF entity 1 selects one SGSN/MME 53 based on the response from the HLR/HSS 51 (i.e., received serving node information). In Step S204, the MTC-IWF entity 1 sends a DTR to the selected SGSN/MME 53. In Step S205, the MTC-IWF entity 1 sends, to the PCRF entity 55, a PCC rule generation indication containing an IP address (i.e., first address) related to the SCS 2 or the MTC application server 4 which has requested the device trigger.

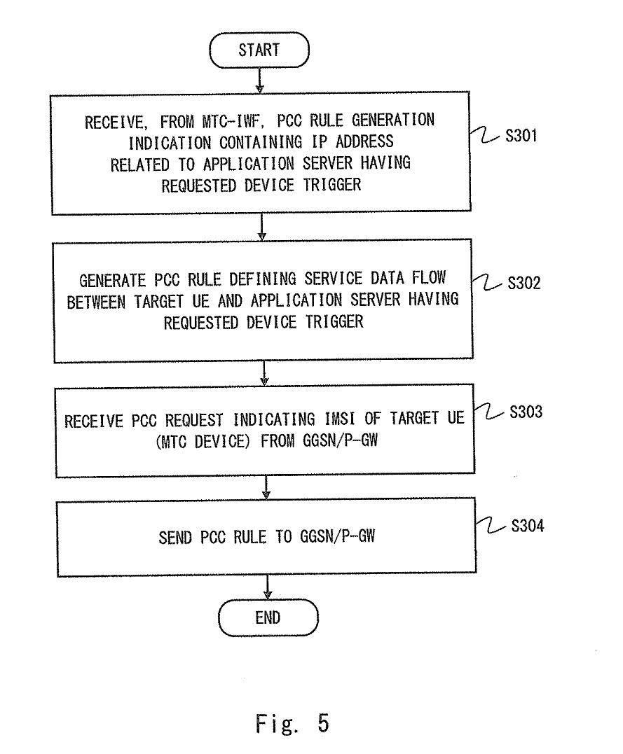

FIG. 5 is a flowchart showing one example of an operation for charging in the PCRF entity 55 according to this embodiment. In Step S301, the PCRF entity 55 receives, from the MTC-IWF entity 1, a PCC rule generation indication containing an IP address (i.e., first address) related to the SCS 2 or the MTC application server 4 which has requested device trigger. In Step S302, the PCRF entity 55 generates a PCC rule that defines a service data flow between the UE 3 (target MTC device) and the SCS 2 or the MTC application server 4, which has requested the device trigger. The PCC rule indicates a charging method and a measurement method necessary to collect charging information per service data flow and create a CDR per service data flow.

In Step S303, the PCRF entity 55 receives a PCC request indicating the IMSI of the UE 3 (target MTC device) from the GGSN/P-GW 54. In Step S304, in response to the PCC request, the PCRF entity 55 sends the PCC rule to the GGSN/P-GW 54. Note that, although the case where the GGSN/P-GW 54 receives the PCC rule in a pull manner is described in Steps S303 and S304, the PCRF entity 55 may send the PCC rule to the GGSN/P-GW 54 in a push manner as described earlier.

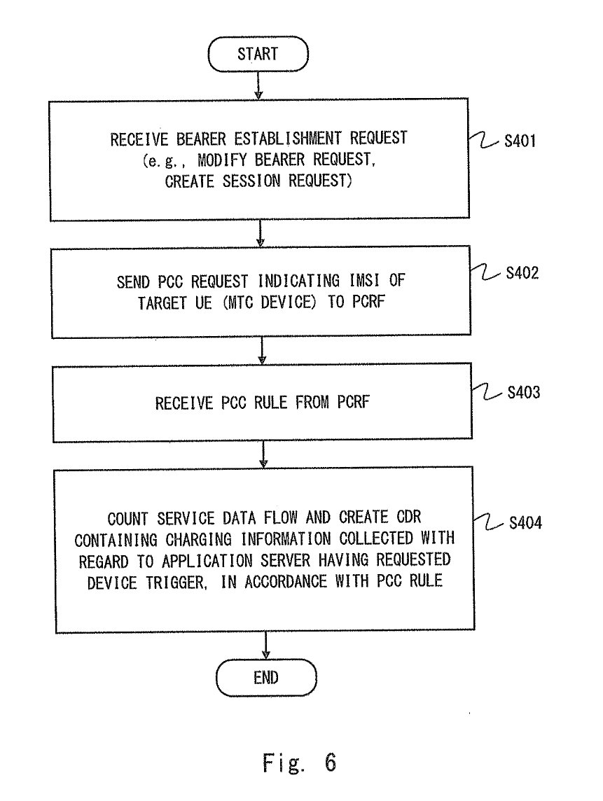

FIG. 6 is a flowchart showing one example of an operation for charging in the GGSN/P-GW 54 according to this embodiment. In Step S401, the GGSN/P-GW 54 receives a bearer establishment request related to the UE 3 (e.g., Modify Bearer Request or Create Session Request from SGSN or S-GW). In Step S402, the GGSN/P-GW 54 sends a PCC request indicating the IMSI of the UE 3 (target MTC device) to the PCRF entity 55. In Step S403, the GGSN/P-GW 54 receives the PCC rule from the PCRF entity 55. The PCC rule defines a service data flow between the UE 3 (target MTC device) and the SCS 2 or the MTC application server 4, which has requested device trigger. The PCC rule also indicates a charging method and a measurement method necessary to collect charging information per service data flow and create a CDR per service data flow. In Step S404, the GGSN/P-GW 54 counts the service data flow and creates a CDR containing the charging information collected with regard to the SCS 2 or the MTC application server 4, which has requested device trigger, in accordance with the PCC rule.

### Second Embodiment

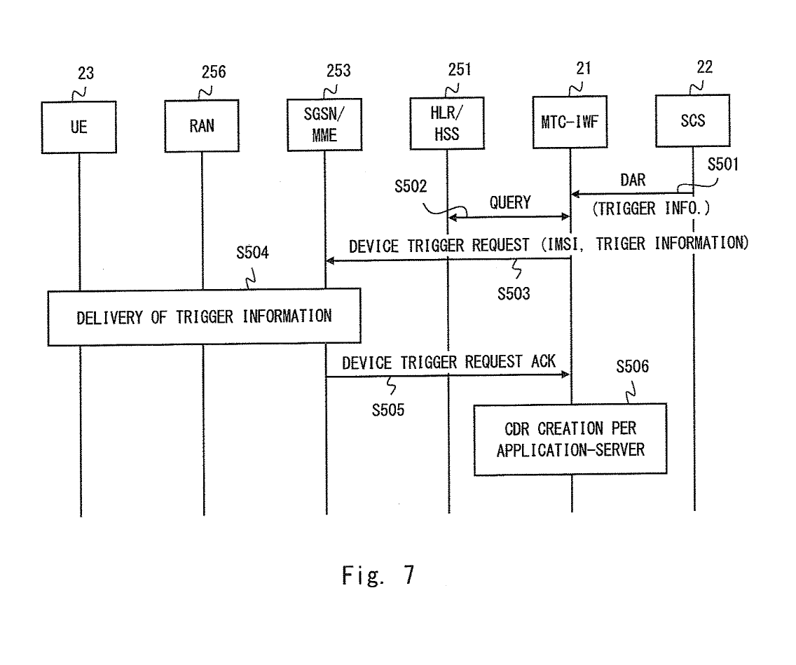

In this embodiment, a method and an apparatus for charging a fee for a device trigger to a party which has requested the device trigger when one MTC device can receive device triggers from a plurality of parties (i.e., an administrator of the SCS, an administrator of the MTC application server, or an MTC service provider) is described. FIG. 7 is a sequence chart showing one example of a charging control method according to this embodiment. In this embodiment, an MTC-IWF entity 21 has a Charging Trigger Function (CTF) and a Charging Data Function (CDF). Specifically, the MTC-IWF entity 21 as the CTF monitors the occurrence of a device trigger as a chargeable event. Then, the MTC-IWF entity 21 as the CDF creates a CDR that contains charging information collected with regard to an SCS 22 or an MTC application server which has requested the device trigger.

In Step S501 of FIG. 7, the SCS 22 sends a device action request (DAR) to the MTC-IWF entity 21. The DAR contains trigger information to be sent to the UE 3. The DAR may further contain an external identifier (e.g., URI) of the UE 23 (target MTC device).

In Step S502, the MTC-IWF entity 21 makes an inquiry to an HLR/HSS 251 about an internal identifier (i.e., IMSI in this example) of the UE 23 corresponding to the external identifier of the UE 23 and about a SGSN/MME 253 (serving node) associated with the UE 23. The MTC-IWF entity 21 selects one SGSN/MME to which a device trigger request (DTR) is to be sent among a plurality of SGSN/MMEs 253 based on a response from the HLR/HSS 251.

In Step S503, the MTC-IWF entity 21 sends the DTR to the selected SGSN/MME 253. The DTR contains the internal identifier (i.e., IMSI in this example) of the UE 23 (target MTC device) and the trigger information to be sent to the UE 23.

In Step S505, the SGSN/MME 253 delivers the trigger information to the UE 23 through a RAN 256. A delivery method of the trigger information may be the same as in Step S104 shown in FIG. 2.

In Step S505, the SGSN/MME 253 sends a response (Device Trigger Request ACK) indicating the success or failure of the device trigger to the MTC-IWF entity 21.

In Step S506, the MTC-IWF entity 21 creates a CDR that contains charging information collected with regard to the SCS 22 or the MTC application server, which has requested the device trigger. The MTC-IWF entity 21 may create a CDR by taking the success or failure of the device trigger into consideration.

According to this embodiment, when one MTC device can receive device triggers from a plurality of parties (i.e., an administrator of the SCS, an administrator of the MTC application server, or an MTC service provider), it is possible to charge a fee for a device trigger to a party who has requested the device trigger.

### Other Embodiments

In the above-described first and second embodiments, specific examples related to the UMTS network and the LTE network specified by the 3GPP are described. Note that, however, the first and second embodiments may be applied to another wireless communication network that supports MTC.

The processing performed by the MTC-IWF entity, the SCS, the MTC application server, the PCRF entity, the GGSN/P-GW, the HLR/HSS, the SGSN/MME and the UE described in the first and second embodiments may be implemented by causing a computer system to execute a program. To be specific, a computer system may be supplied with one or more programs including instructions to cause the computer system to perform algorithms described using the flowcharts, the sequence charts and the like in this specification.

These programs can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). These programs may be provided to a computer using any type of transitory computer readable medium. Examples of the transitory computer readable medium include electric signals, optical signals, and electromagnetic waves. The transitory computer readable medium can provide these programs to a computer via a wired communication line such as an electric wire or optical fiber or a wireless communication line.

Further, the above-described embodiments are merely examples of applications of technical ideas obtained by the inventor. Accordingly, these technical ideas are not limited to the above-described embodiments, and various changes and modifications may be made on these technical ideas.

This application is based upon and claims the benefit of priority from Japanese patent application No. 2013-167630, filed on Aug. 12, 2013, the disclosure of which is incorporated herein in its entirety by reference.

### REFERENCE SIGNS LIST

1 Machine Type Communication Inter Working Function (MTC-IWF) entity
2 Service Capability Server (SCS)
3 User Equipment (UE)
4 MTC application server
5 Public Land Mobile Network (PLMN)
10 device-trigger control unit
31 MTC UE application
51 Home Location Register/Home Subscriber Server (HLR/HSS)
52 Short Message Service-Service Center (SMS-SC)
53 Serving General Packet Radio Service (GPRS) Support Node/Mobility Management Entity (SGSN/MME)
54 Gateway GPRS Support Node/Packet Data Network Gateway (GGSN/P-GW)
55 Policy and Charging Rule Function (PCRF)
56 Radio Access Network (RAN)

1. A wireless communication system comprising:
a controller comprising at least one hardware processor configured to send a charging rule generation indication to a Policy and Charging Rule Function (PCRF) entity in response to receiving, from a Service Capability Server (SCS), a device action request containing trigger information to be sent to a Machine Type Communication (MTC) device, wherein
the charging rule generation indication contains a first address specifying a node or a network with which the MTC device communicates when the MTC device receives the trigger information.

2. The wireless communication system according to claim 1, wherein
the charging rule generation indication triggers the PCRF entity to generate a charging rule, and
the charging rule is supplied from the PCRF entity to a packet transfer node placed in a core network and is used by the packet transfer node for creating a Charging Data Record (CDR) containing charging information collected with regard to the first address.

3. The wireless communication system according to claim 2, wherein the charging rule defines at least one of an uplink packet flow where the first address is designated as a destination address and a downlink packet flow where the first address is designated as a source address.

4. The wireless communication system according to claim 1, wherein the first address is an Internet Protocol (IP) address of the SCS, a network address of the SCS, an IP address of an application server having requested the device action request to the SCS, or a network address of the application server.

5. The wireless communication system according to claim 1, wherein
the device action request contains the first address, and
the first address is sent to the MTC device by delivery of the trigger information.

6. A method for charging control comprising:
sending a charging rule generation indication to a Policy and Charging Rule Function (PCRF) entity in response to receiving, from a Service Capability Server (SCS), a device action request containing trigger information to be sent to a Machine Type Communication (MTC) device, wherein
the charging rule generation indication contains a first address specifying a node or a network with which the MTC device communicates when the MTC device receives the trigger information.

7. A non-transitory computer readable medium storing a program causing a computer to perform a method for charging control, the method comprising:
sending a charging rule generation indication to a Policy and Charging Rule Function (PCRF) entity in response to receiving, from a Service Capability Server (SCS), a device action request containing trigger information to be sent to a Machine Type Communication (MTC) device, wherein
the charging rule generation indication contains a first address specifying a node or a network with which the MTC device communicates when the MTC device receives the trigger information.

8. A Machine Type Communication Inter Working Function (MTC-IWF) entity comprising:
at least one hardware processor configured to send a charging rule generation indication to a Policy and Charging Rule Function (PCRF) entity in response to receiving, from a Service Capability Server (SCS), a device action request containing trigger information to be sent to an MTC device, wherein
the charging rule generation indication contains a first address specifying a node or a network with which the MTC device communicates when the MTC device receives the trigger information.

9. A wireless communication system comprising:
a Machine Type Communication Inter Working Function (MTC-IWF) entity;
a Policy and Charging Rule Function (PCRF) entity; and
a packet transfer node, wherein
the MTC-IWF entity is configured to receive from a Service Capability Server (SCS) a device action request containing trigger information,
the MTC-IWF entity is configured to send a device trigger request containing the trigger information to a serving node in response to receiving the device action request,
the MTC-IWF entity is configured to send a charging rule generation indication to the Policy and Charging Rule Function (PCRF) entity in response to receiving the device action request,
the charging rule generation indication contains a first address specifying a node or a network with which a target MTC device communicates on a user plane in response to delivery of the trigger information based on the device trigger request,
the PCRF entity is configured to generate a charging rule in response to the charging rule generation indication,
the charging rule defines at least one of an uplink packet flow to be sent from the target MTC device where the first address is designated as a destination address and a downlink packet flow to be sent to the target MTC device where the first address is designated as a source address,
the PCRF entity is configured to send the charging rule to a packet transfer node placed in a core network, and
the packet transfer node is configured to count at least one of the uplink packet flow and the downlink packet flow based on the charging rule and create a Charging Data Record (CDR) containing charging information collected with regard to the first address.
